(19) United States
(12) Patent Application Publication
(10) Pub. No.: US 2012/0319970 A1
(43) Pub. Date: Dec. 20, 2012

(54) DETECTION CIRCUIT AND DETECTION METHOD FOR TOUCH-SENSING PANEL

(75) Inventors: WEI FEN LIN, Hsinchu County (TW); SHANG PING TANG, Hsinchu City (TW)

(73) Assignee: RAYDIUM SEMICONDUCTOR CORPORATION, HSINCHU (TW)

(21) Appl. No.: 13/494,271

(22) Filed: Jun. 12, 2012

(30) Foreign Application Priority Data
Jun. 16, 2011 (TW) 100120989

(51) Int. Cl. G06F 3/041

(52) U.S. Cl. 345/173; 178/18.03

(57) ABSTRACT

A detection circuit for a touch-sensing panel includes a successive approximation register analog-to-digital converter (SAR-ADC) and a timing control device. The SAR-ADC is configured to detect a coupling voltage to generate a multi-bit digital detection value. The timing control device is configured to control a detection time of each bit for the SAR-ADC.

### BACKGROUND

1. Technical Field

The present invention relates to a detection circuit and a detection method for a touch-sensing panel.

2. Related Art

A touch-sensing panel is an electronic display device, which detects a touch status and a touched position when an object touches a display area of the touch-sensing panel, thereby allowing a user to interact with the touch-sensing panel without using a keyboard or a mouse, and further control a device connected to the touch-sensing panel. Because of the aforementioned characteristic, operating the touch-sensing panel is more intuitive and closer to human nature compared to operating other human-machine interfaces.

FIG. 1 is a schematic diagram illustrating a common capacitive touch-sensing panel and its detection circuit presently available. As illustrated in FIG. 1, the touch-sensing panel 102 may be divided into a plurality of touch-sensing areas, and may connect to a detection circuit 104 through X-axis electrodes X1 to X6 and Y-axis electrodes Y1 to Y6. Each touch-sensing area has a respective sensor. The stripe-marked diamond-shaped touch sensing areas are connected to X-axis sensors, and the dot-marked diamond-shaped sensing areas are connected to Y-axis sensors. The detection circuit 104 includes a multiplexer 106, an analog-to-digital converter 108, a control register set 110 and a control interface 112. The multiplexer 106 is configured to switch among outputting output voltage signals of the X-axis electrodes and the Y-axis electrodes to the analog-to-digital converter 108. The analog-to-digital converter 108 is configured to convert the received output signals to digital signals. The control register set 110 is configured to store various parameter settings of the detection circuit 104, including the settings for sensing electrodes, the settings for driving electrodes, and the settings for an amplification factor and a detection time of the analog-to-digital converter 108. The control interface 112 serves as an interface to other devices such as a microprocessor, and may receive control signals.

Under normal operations, the X-axis electrodes and the Y-axis electrodes periodically output voltage signals to the detection circuit 104. When an object touches a control area of the touch-sensing panel 102, the object causes an equivalent capacitance of the touch-sensing area to increase, which in turn causes an output voltage signal of the X-axis electrode or Y-axis electrode of the touch-sensing area to change. Therefore, the detection circuit 104 may use the intersection of the specific X-axis electrode and the specific Y-axis electrode to identify the location of the touch-sensing area.

Many common applications use a successive approximation register analog-to-digital converter (SAR-ADC) for the analog-to-digital converter 108. The operating principle of the SAR-ADC involves generating a digital detection value from the most significant bit to the least significant bit in order using an approach similar to binary search. Typically, the SAR-ADC includes a comparator configured to compare a voltage to be measured with a digital output value of the SAR-ADC to generate the value of the next bit.

However, how to determine for the SAR-ADC a detection time for each bit is a difficult problem in circuit design and application. FIG. 2 is a diagram illustrating variations of coupling voltage of the detection circuit 104 with respect to different loads. As shown in FIG. 2, when the load is light, the voltage of the touch-sensing area reaches the driving voltage V_{DRV} quickly. However, when the load is heavy, it takes a longer time for the voltage of the touch-sensing area to reach the driving voltage V_{DRV}. With the current trend towards increasingly larger-sized panels, which are equivalent to heavy loads, the detection circuit of the touch-sensing panel must be capable to handle a heavy load. Under the situation of heavy load, if analog to digital conversion is performed before the coupling voltage is stable, an error rate will increase. If the detection time is extended to reach a stable coupling voltage, a reporting rate of the detection circuit will drop.

### SUMMARY

The present invention discloses a detection circuit for a touch-sensing panel, including a successive approximation register analog-to-digital converter (SAR-ADC) and a timing control device. The SAR-ADC is configured to detect a coupling voltage to generate a multi-bit digital detection value. The timing control device is configured to control a detection time of each bit for the SAR-ADC.

The present invention discloses a detection method for a touch-sensing panel, including the steps of: detecting a coupling voltage of the touch-sensing panel, and generating a multi-bit digital detection value, wherein the digital detection value is generated from the most significant bit to the least significant bit in order, and a detection time of a more significant bit of the digital detection value is longer than that of a less significant bit of the digital detection value.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become easily comprehensible upon reading the following description and upon reference to the accompanying drawings, in which:

FIG. 1 is a schematic diagram illustrating a common capacitive touch-sensing panel and its detection circuit presently available;

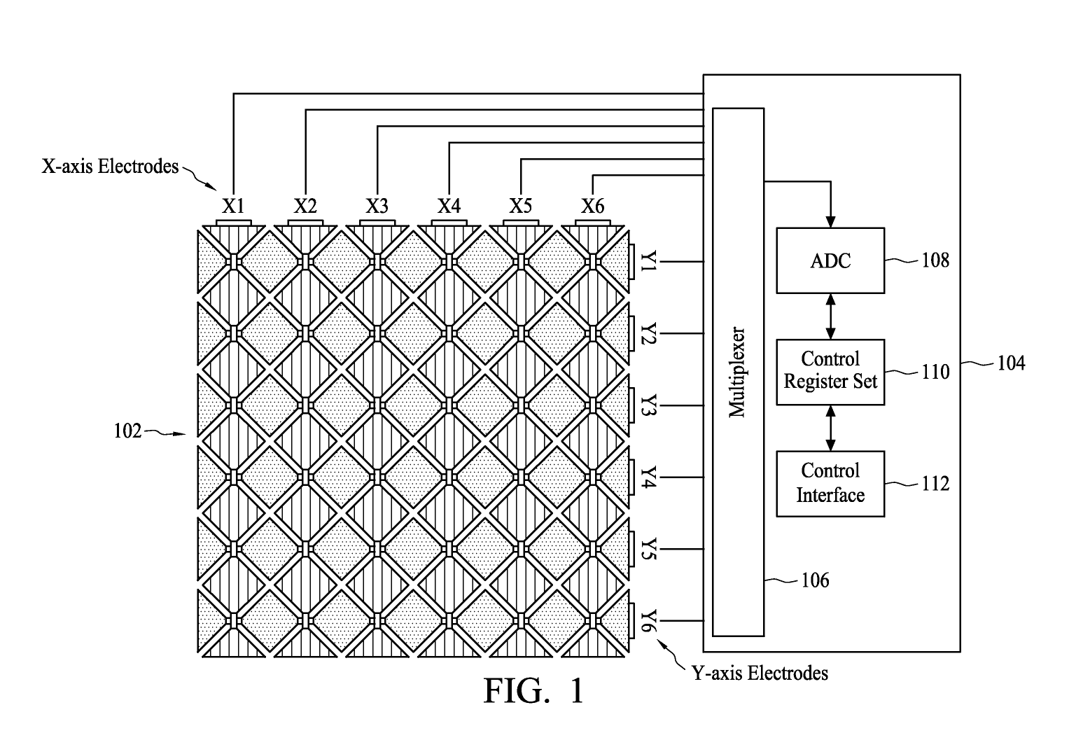

FIG. 2 is a diagram illustrating variations of coupling voltage of a prior art detection circuit with respect to different loads;

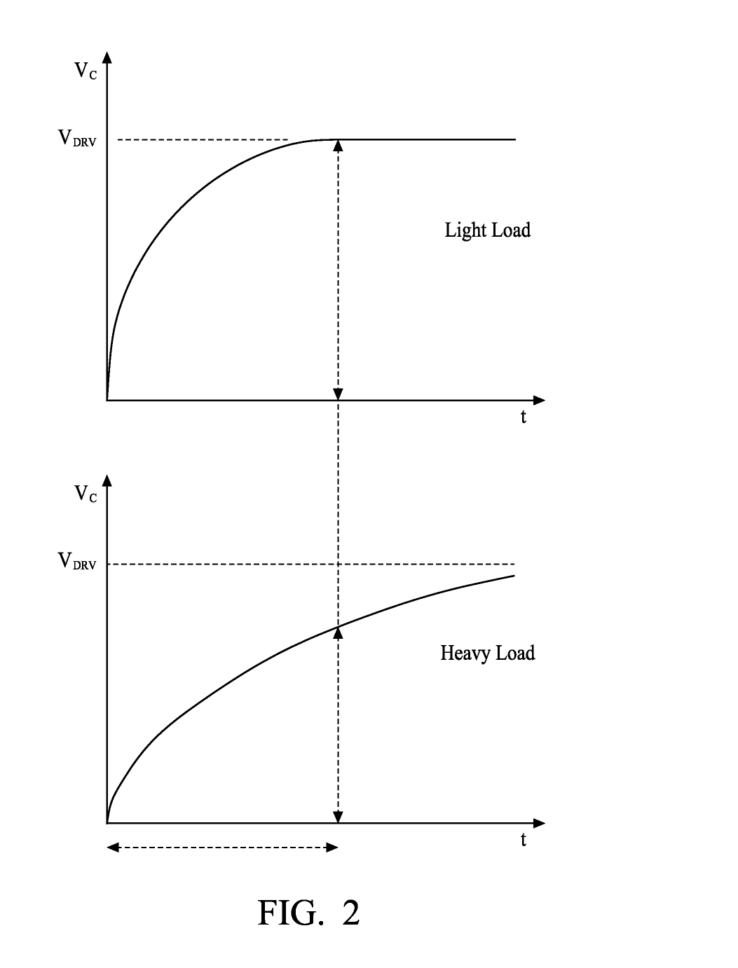

FIG. 3 is a schematic diagram illustrating a detection circuit for a touch-sensing panel according to an embodiment of the present invention;

FIG. 4 is a timing diagram for several signals of the detection circuit according to an embodiment of the present invention; and

FIG. 5 is a flow chart illustrating a detection method for a touch-sensing panel according to an embodiment of the present invention.

### DESCRIPTION OF THE EMBODIMENTS

The present invention is directed to a detection circuit and method for a touch-sensing panel. In order for the present invention to be fully understood, detail steps and configurations are provided in the following description. Clearly, implementations of the present invention are not limited to the specific details people having ordinary skills in the art are familiar with. In addition, well known configurations or steps are not described in detail to avoid imposing unnecessary limitations on the present invention. The preferred embodiments of the present invention will be described in detail in the following. However, in addition to the detailed description, the present invention may be broadly implemented in other embodiments. The scope of the present invention is not limited by the detailed description and is defined by the appended claims.

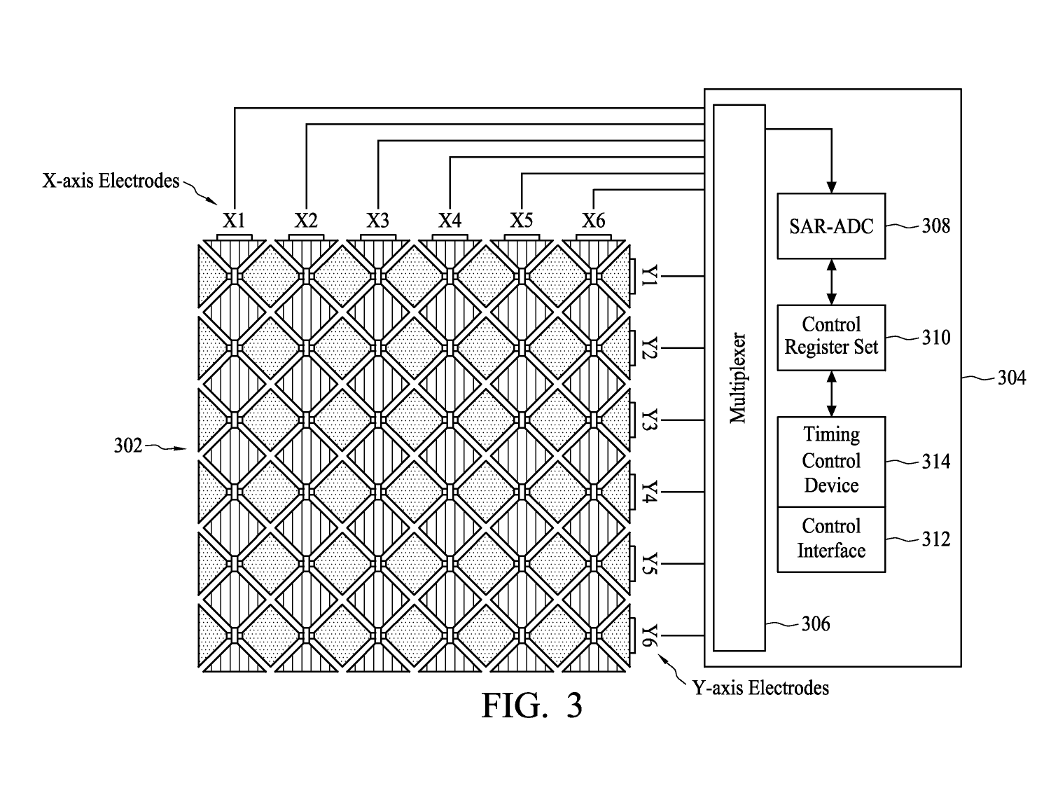

FIG. 3 is a schematic diagram illustrating a detection circuit for a touch-sensing panel according to an embodiment of the present invention. As illustrated in FIG. 3, the detection circuit 304 is connected to a touch-sensing panel 302, and includes a multiplexer 306, a successive approximation register analog-to-digital converter (SAR-ADC) 308, a control register set 310, a control interface 312, and a timing control device 314. The touch-sensing panel 302 may be divided into a plurality of control areas and connect to the detection circuit 304 through X-axis electrodes X1 to X6 and Y-axis electrodes Y1 to Y6, wherein each control area has a respective sensor. The multiplexer 306 is configured to switch among outputting voltage signals of the X-axis electrodes and the Y-axis electrodes to the SAR-ADC 308. The SAR-ADC 308 is configured to convert the received output voltage signal into a multi-bit digital detection value. The timing control device 314 is configured to control a detection time of each bit for the SAR-ADC 308. The control register set 310 is configured to store various parameter settings of the detection circuit 304, including settings for sensing electrodes, settings for driving electrodes, and settings for an amplification factor and a detection time of each bit of the SAR-ADC 308. The control interface 312 serves as an interface to other devices, such as a microprocessor, and may receive control signals.

With regards to the output digital detection value of the SAR-ADC 308, the value of a more significant bit is more important than the value of a less significant bit. In other words, the more significant the bit of the analog to digital conversion result is, the larger the impact to the correct rate of the digital detection value. Accordingly, the timing control device 314 may control the SAR-ADC 308 to have a longer detection time for the more significant bit compared to the detection time for the less significant bit, so as to increase the correct rate of the more significant bit of the digital detection value.

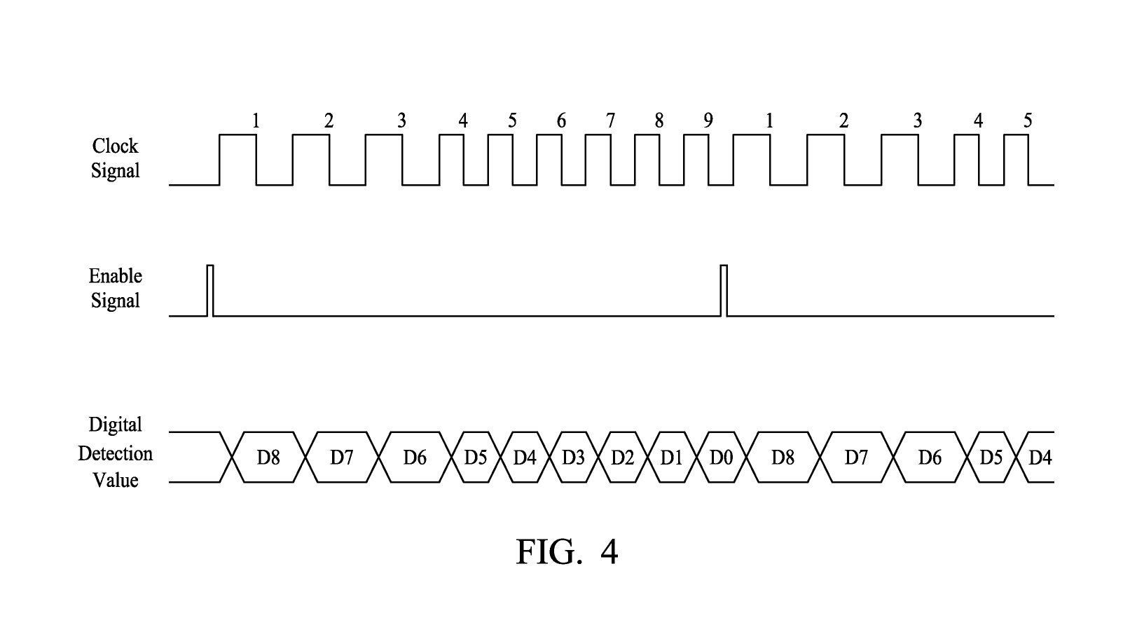

According to some embodiments of the present invention, the SAR-ADC 308 generates one bit value of the multi-bit digital detection value in one period according to a clock signal. FIG. 4 is a timing diagram illustrating several signals of the detection circuit 304, wherein the digital detection value includes D8 to D0, a total of 9 bits. As illustrated in FIG. 4, when an enable signal outputs a pulse, the SAR-ADC 308 performs analog to digital conversion of the received coupling voltage from the most significant bit to the least significant bit. The timing control device 314 then increases the periods of the clock pulse with respect to the more significant bits, i.e. increases the detection times of the more significant bits of the digital detection value of the SAR-ADC 308. Therefore, the detection circuit 304 may significantly enhance the correct rate of the analog to digital conversion without unduly reducing the reporting rate.

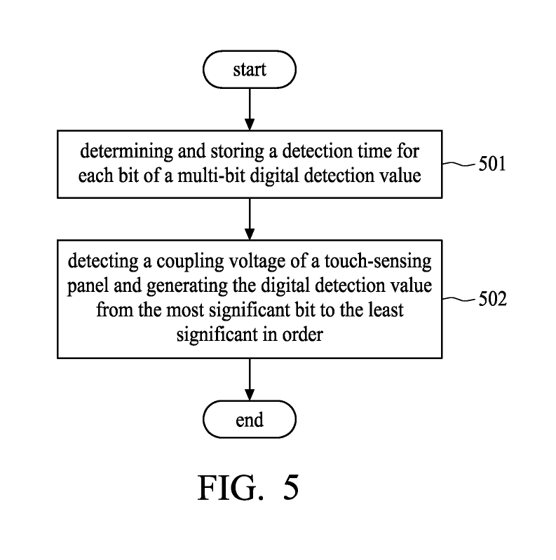

FIG. 5 is a flow chart of a detection method for a touch-sensing panel according to an embodiment of the present invention, which may be applied to the detection circuit 304 show in FIG. 3. In step 501, a detection time for each bit of a multi-bit digital detection value is determined and stored, and is followed by step 502, wherein a detection time of a more significant bit is longer than that of a less significant bit. In step 502, a coupling voltage of a touch-sensing panel is detected, and the multi-bit detection value is generated from the most significant bit to the least significant bit in order.

To summarize the foregoing description, the detection circuit and method for the touch-sensing panel of the present invention control a detection time for each bit during analog to digital conversion, thereby increasing a correct rate without unduly decreasing a reporting rate.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A detection circuit for a touch-sensing panel, comprising:
a successive approximation register analog-to-digital converter (SAR-ADC), configured to detect a coupling voltage to generate a multi-bit digital detection value; and
a timing control device, configured to control a detection time of each bit for the SAR-ADC.

2. The detection circuit according to claim 1, further comprises a control register set, configured to store the detection time of each bit for the SAR-ADC.

3. The detection circuit according to claim 1, wherein the timing control device is configured to control the detection time of each bit for the SAR-ADC such that the detection time of a more significant bit is longer than that of a less significant bit for the SAR-ADC.

4. The detection circuit according to claim 1, wherein the SAR-ADC generates the multi-bit digital detection value in response to a clock signal.

5. The detection circuit according to claim 4, wherein a duty cycle of the clock signal is controlled by the timing control device.

6. A detection method for a touch-sensing panel, comprising the steps of:
detecting a coupling voltage of the touch-sensing panel, and generating a multi-bit digital detection value, wherein the digital detection value is generated from the most significant bit to the least significant bit in order, and a detection time of a more significant bit of the digital detection value is longer than that of a less significant bit of the digital detection value.

7. The detection method according to claim 6, further comprising the steps of:
determining and storing a detection time for each bit of the digital detection value.

8. The detection method according to claim 6, wherein the detecting step generates each bit of the digital detection value based on a clock signal.
